(19) United States
(12) Patent Application Publication
(10) Pub. No.: US 2002/0012290 A1
(43) Pub. Date: Jan. 31, 2002

(54) Local time calculator, time-measuring device, communication terminal device and local time calculating method

(75) Inventor: Yuuichi Shinagawa, Fujisawa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/819,648

(22) Filed: Mar. 29, 2001

(30) Foreign Application Priority Data
Jul. 12, 2000 (JP) 2000-175510

(51) Int. Cl. G04B 19/22

(52) U.S. Cl. 368/21

(57) ABSTRACT

A GPS reception section receives radio signals from a plurality of positioning satellites, and finds a latitude and a longitude of the device in which the GPS reception section is included, on the basis of information contained in the radio signals. The GPS reception section sends the information on the latitude and longitude to a calculation section as position information, extracts GMT time information and date information from the received radio signals, and outputs the information to the calculator. The calculation section reads out, from the database section, the time difference information and summer time information associated with the position information provided from the GPS reception section. Based on the read-out information, the calculation section subjects the time information provided from the GPS reception section to predetermined arithmetic processes and calculates a local time. A display section displays the calculated local time.

### CROSS-REFERENCE TO RELATED APPLICATIONS

This application is based upon and claims the benefit of priority from the prior Japanese Patent Application No. 2000-175510, filed Jun. 12, 2000, the entire contents of which are incorporated herein by reference.

### BACKGROUND OF THE INVENTION

1. Field of the Invention

The present invention relates, for example, to a local time calculator for use in finding a time in a country or a region to which one has moved, a local time calculating method, a time-measuring device indicating a local time, and a communication terminal device.

2. Description of the Related Art As is well known, aside from Greenwich Mean Time (GMT) or a coordinated universal time, so-called local times are set in the respective countries or regions on the earth so as to match with peoples living there. The local times are approximately set according to the longitude of the locations of the countries or regions.

With modern developments of airplanes, etc., more people have moved frequently among countries or regions, and one has to adjust his/her timepiece to confirm to the local time where he/she has moved.

When one adjusts the time according to the location where he/she has moved, it is necessary to understand a time difference between a pre-movement position and a post-movement position. A great deal to time and labor are consumed for people who move frequently.

### BRIEF SUMMARY OF THE INVENTION

The object of the present invention is to provide a local time calculator, a time-measuring device, a communication terminal device and a local time calculating method, with which even if one moves between countries or regions where there is a time difference, it is possible to automatically adjust a display time on a timepiece according to a location where one has moved, without the read to understand a time difference in advance.

In order to achieve the object, the invention of claim 1 provides a local time calculator comprising: storage means for storing time difference information in association with a plurality of different position information items; arithmetic operation means for obtaining a local time at a current position on the basis of the time difference information corresponding to the current position information, which is stored in the storage means, and a present mean time; and indicator means for indicating the local time obtained by the arithmetic operation means.

According to the local time calculator with the above structure, time difference information is prestored in the storage means in association with plural position information items. A time difference from a mean time is found from the current position information. The time difference is reflected on the mean time to find the local time.

Thus, with the local time calculator having the above structure, even if the user moves to a country or a region with a time difference, the display time on the timepiece can automatically be adjusted in accordance with the country or region.

In order to achieve the object, the invention of claim 1 provides a time-measuring device comprising: information acquisition means for receiving a radio signal from positioning satellites and acquiring position information representing a current position and time information representing a mean time; storage means for storing time difference information in association with a plurality of different position information items; arithmetic operation means for obtaining a local time at a current position on the basis of the time difference information corresponding to the current position information, which is stored in the storage means, and the time information acquired by the information acquisition means; and indicator means for indicating the local time obtained by the arithmetic operation means.

According to the time-measuring device with the above structure, time difference information is prestored in the storage means in association with plural position information items. Current position information and a mean time are acquired from a radio signal sent from the positioning satellite, and a time difference from a mean time is found from the current position information. The time difference is reflected on the mean time to find the local time.

Thus, with the time-measuring device having the above structure, even if the user moves to a country or a region with a time difference, the display time on the timepiece can automatically be adjusted in accordance with the country or region on the basis of the radio signal received from the positioning satellite, without the need to understand the time difference in advance.

In order to achieve the object, the invention of claim 5 provides a communication terminal device for communication via a network, comprising: information acquisition means for receiving a radio signal from a GPS (Global Positioning system) satellite and acquiring position information representing a current position and time information representing a mean time; storage means for storing time difference information in association with a plurality of different position information items; arithmetic operation means for obtaining a local time at a current position on the basis of the time difference information corresponding to the current position information, which is stored in the storage means, and the time information acquired by the information acquisition means; and indicator means for indicating the local time obtained by the arithmetic operation means.

According to the communication terminal device with the above structure, time difference information is prestored in the storage means in association with plural position information items. Current position information and a mean time are acquired from a radio signal sent from the positioning satellite, and a time difference from a mean time is found from the current position information. The time difference is reflected on the mean time to find the local time.

Thus, with the communication terminal device having the above structure, even if the user moves to a country or a region with a time difference, the display time on the timepiece can automatically be adjusted in accordance with the country or region on the basis of the radio signal received from the positioning satellite, without the need to understand the time difference in advance.

In order to achieve the object, the invention of claim 7 provides a communication terminal device for communication via a network, comprising: information acquisition means for acquiring via the network position information representing a current position and time information representing a mean time; storage means for storing time difference information in association with a plurality of different position information items; arithmetic operation means for obtaining a local time at a current position on the basis of the time difference information corresponding to the current position information, which is stored in the storage means, and the time information acquired by the information acquisition means; and indicator means for indicating the local time obtained by the arithmetic operation means.

According to the communication terminal device with the above structure, time difference information is prestored in the storage means in association with plural position information items. Current position information and a mean time are acquired via a network, and a time difference from a mean time is found from the current position information. The time difference is reflected on the mean time to find the local time.

Thus, with the communication terminal device having the above structure, even if the user moves to a country or a region with a time difference, the display time on the timepiece can automatically be adjusted in accordance with the country or region on the basis of the information acquired via the network, without the need to understand the time difference in advance.

In order to achieve the object, the invention of claim 9 provides a local time calculation method comprising: a first acquisition step of acquiring a current position and a present mean time; a second acquisition step of acquiring time difference information associated with the current position acquired in the first acquisition step; arithmetic operation step of obtaining a local time at the current position on the basis of the present mean time acquired in the first acquisition step and the time difference information acquired in the second acquisition step; and indicating step of indicating the local time obtained in the arithmetic operation step.

According to the local time calculation method with the above constitution, information representing a mean time and time difference information associated with a current position are acquired, and a time difference is reflected on the mean time to find the local time.

Thus, with the local time calculation method having the above constitution, even if the user moves to a country or a region with a time difference, the display time on the timepiece can automatically be adjusted in accordance with the country or region, without the need to understand the time difference in advance.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a circuit block diagram showing the structure of an embodiment of a time-measuring device according to the present invention;

FIG. 2 is a flow chart illustrating the operation of the time-measuring device shown in FIG. 1;

FIG. 3 shows an example of a system structure wherein the time-measuring device shown in FIG. 1 is applied to a mobile phone; and

FIG. 4 shows an example of a system structure wherein the time-measuring device shown in FIG. 1 is applied to a personal computer.

### DETAILED DESCRIPTION OF THE INVENTION

An embodiment of the present invention will now be described with reference to the accompanying drawings.

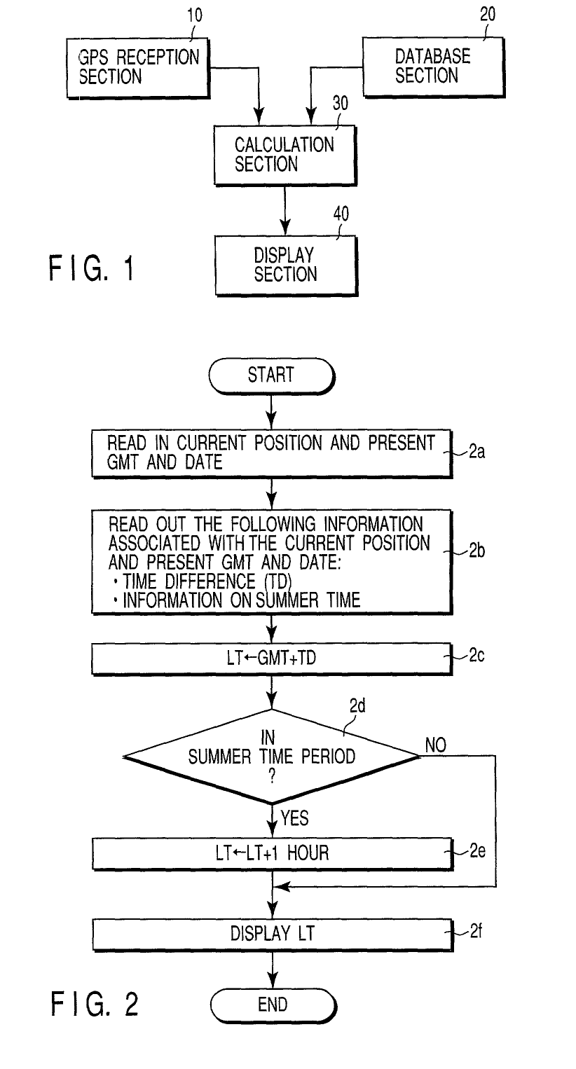

FIG. 1 shows the structure of a time-measuring device according to an embodiment of the present invention.

This time-measuring device is a small-sized timepiece such as a watch, which comprises a GPS (Global Positioning System) reception section 10, a database section 20, a calculation section 30, and a display section 40.

The GPS reception section 10 receives radio signals from a plurality of positioning satellites such as GPS satellites (not shown). The GPS reception section 10 finds a latitude and a longitude of the device in which the GPS reception section 10 is included, on the basis of information contained in the radio signals. The GPS reception section 10 sends the information on the latitude and longitude to the calculation section 30 as position information. In addition, the GPS reception section 10 extracts GMT time information and date information from the received radio signals and outputs the information to the calculator 30.

The database section 20 stores time differences and summer time information in association with various position information of the latitude and longitude.

The calculation section 30 reads out, from the database section 20, time difference information TD and summer time information associated with the position information provided from the GPS reception section 10. Based on the read-out information, the calculation section 30 subjects the time information provided from the GPS reception section 10 to predetermined arithmetic processes and calculates a local time.

The display section 40 comprises, for example, an LCD (Liquid Crystal Display). The local time calculated by the calculation section 30 is input to the display section 40 and the local time is visually indicated.

The operation of the time-measuring device with the above-described structure will now be described. FIG. 2 is a flow chart illustrating the operation. The operation in FIG. 2 is repeatedly carried out by the calculation section 30 at a predetermined cycle (one second or less).

In step 2a, latest position information obtained by the GPS reception section 10 is read from the GPS reception section 10. In addition, latest GMT and date data obtained by the GPS reception section 10 are read from the GPS reception section. Control then goes to step 2b.

In step 2b, on the basis of the position information obtained in step 2a, the associated time difference information TD and summer time information is read out. Control then advances to step 2c.

In step 2c, the time difference TD read in step 2b is added to the GMT read in step 2a. The added result is used as local time LT, and control advances to step 2d.

In step 2d, based on the position information and date information read in step 2a and the summer time information read in step 2b, it is determined whether the summer time is presently practiced in a country or a region of the current position. If the summer time is practiced, control goes to step 2e. If not, control goes to step 2f.

In step 2e, one hour is added to the local time LT obtained in step 2c, and control goes to step 2f.

In step 2f, the information on the local time LT is output to the display section 40, and the present process is completed. Then, a predetermined cyclic time has passed, the process is carried out once again from step 2a.

As has been described above, in the time-measuring device with the above structure, based the information acquired from the positioning satellite, the present GMT is obtained and the current position is found. The time difference corresponding to the current position is added to the GMT to obtain the time at the current position, that is, the local time. The local time is displayed on the display section 40.

According to the time-measuring device with the above structure, wherever the user of the device goes, the local time of the country or region where the user of the time-measuring device is staying can be automatically displayed on the display section 40 on the basis of the information acquired from the positioning satellite. Thus, the user can understand the local time of the area where he/she has come, without understanding the time difference in advance.

In addition, in the time-measuring device with the above-described structure, the periods of the summer time in the respective countries or regions are recognized on the basis of the date information acquired from the positioning satellite and the summer time information stored in the database section 20. When the summer time is practiced, the local time is adjusted in accordance with the summer time.

Thus, according to the time-measuring device with the above structure, the user can understand the local time in the summer time period, without being conscious of the summer time period.

The present invention is not limited to the above-described embodiment. For example, the use of the watch is assumed in the above embodiment. However, any kind of timepiece can be used. A timepiece provided in a portable radio or a PDA (Personal Digital Assistance) may be used.

Recently, there has been a trend to realize an international roaming system, with which one mobile phone can be used in plural countries or regions. The time-measuring device can be applied to the international roaming system so that the timepiece function of the mobile phone may be adjusted according to the local time of the country or region to which the user has moved.

In most of radiophone systems including a mobile phone system, the call fees vary according to the time slot of use. It is thus important for the user to exactly understand the local time.

If the present invention is applied to the radio phone terminal, the local time of the country or region to which the user has moved can be exactly reported to the user, and the convenience for the user is greatly enhanced.

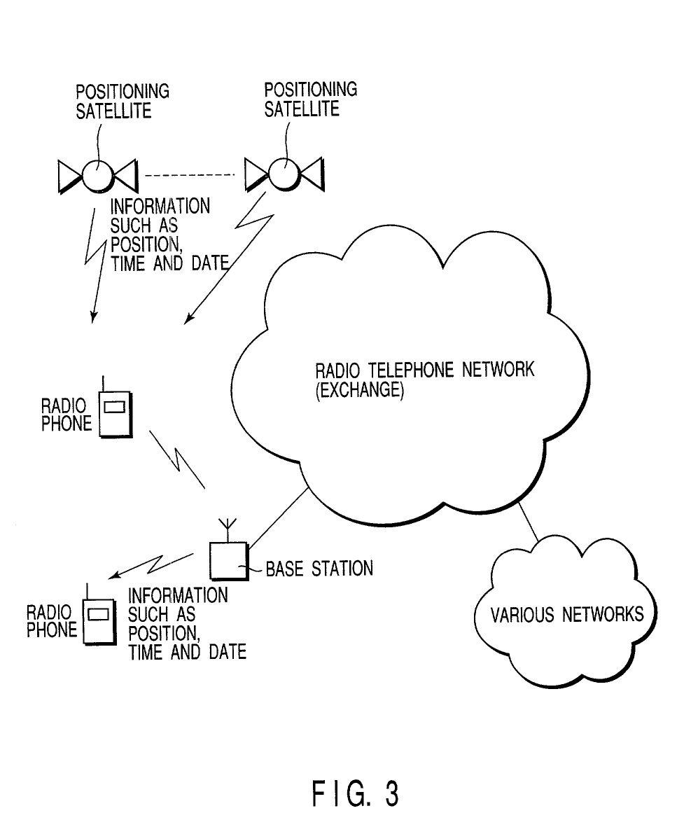

In the case where the time-measuring device of this invention is applied to the radio phone system, as shown in FIG. 3, the position information, time information and date information is not acquired from the radio signal from the positioning satellite. Instead, the information is acquired from a base station or an exchange to which the radiophone is wirelessly connected, and the local time of the country or region where the user has move is obtained.

Recently, the Internet has widely been utilized by means of small-sized computers such as personal computers. If the time-measuring device of the present invention is applied to such computers, the timepiece function of the computer can be adjusted in accordance with the local time.

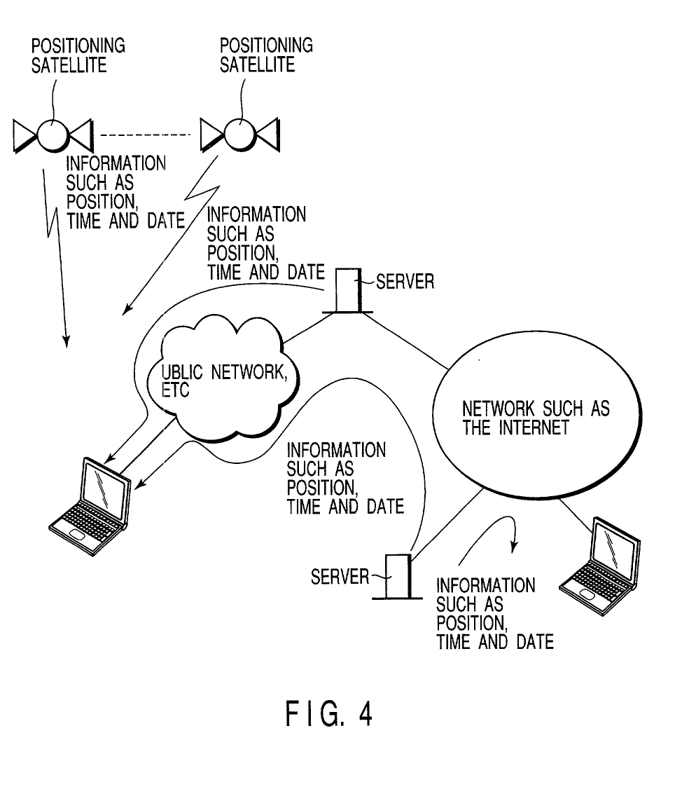

In the case where the time-measuring device of this invention is applied to the computer, as shown in FIG. 4, the position information, time information and date information is not acquired from the radio signal from the positioning satellite. Instead, the information is acquired via a wired network from a server of a service provider via which the computer is connected to the Internet, or a server on the Internet. Thereby, the local time of the country or region where the user has move is obtained.

Needless to say, various modifications may be made to the present invention without departing from the spirit of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A local time calculator comprising:
storage means for storing time difference information in association with a plurality of different position information items;
arithmetic operation means for obtaining a local time at a current position on the basis of the time difference information corresponding to the current position information, which is stored in the storage means, and a present mean time; and
indicator means for indicating the local time obtained by the arithmetic operation means.

2. A local time calculator according to claim 1, wherein said storage means stores summer time information indicating time periods in which summer time is practiced, in association with the different position information items, and
the arithmetic operation means determines whether a present date falls within the time period in which the summer time is practiced, on the basis of the summer time information associated with the current position information, which is stored in the storage means, and if the present date falls within the time period in which the summer time is practiced, the arithmetic operation means adjusts the local time in accordance with the summer time.

3. A time-measuring device comprising:
information acquisition means for receiving a radio signal from positioning satellites and acquiring position information representing a current position and time information representing a mean time;
storage means for storing time difference information in association with a plurality of different position information items;
arithmetic operation means for obtaining a local time at a current position on the basis of the time difference information corresponding to the current position information, which is stored in the storage means, and the time information acquired by the information acquisition means; and
indicator means for indicating the local time obtained by the arithmetic operation means.

4. A time-measuring device according to claim 3, wherein said information acquisition means acquires date information by means of a radio signal from the positioning satellite,
said storage means stores summer time information indicating time periods in which summer time is practiced, in association with the different position information items, and
the arithmetic operation means determines whether the date information acquired by the information acquisition means falls within the time period in which the summer time is practiced, on the basis of the summer time information associated with the current position information, which is stored in the storage means, and if the date information falls within the time period in which the summer time is practiced, the arithmetic operation means adjusts the local time in accordance with the summer time.

5. A communication terminal device for communication via a network, comprising:
information acquisition means for receiving a radio signal from a GPS (Global Positioning system) satellite and acquiring position information representing a current position and time information representing a mean time;
storage means for storing time difference information in association with a plurality of different position information items;
arithmetic operation means for obtaining a local time at a current position on the basis of the time difference information corresponding to the current position information, which is stored in the storage means, and the time information acquired by the information acquisition means; and
indicator means for indicating the local time obtained by the arithmetic operation means.

6. A communication terminal device according to claim 5, wherein said information acquisition means acquires date information by means of a radio signal from the GPS satellite,
said storage means stores summer time information indicating time periods in which summer time is practiced, in association with the different position information items, and
the arithmetic operation means determines whether the date information acquired by the information acquisition means falls within the time period in which the summer time is practiced, on the basis of the summer time information associated with the current position information, which is stored in the storage means, and if the date information falls within the time period in which the summer time is practiced, the arithmetic operation means adjusts the local time in accordance with the summer time.

7. A communication terminal device for communication via a network, comprising:
information acquisition means for acquiring via said network position information representing a current position and time information representing a mean time;
storage means for storing time difference information in association with a plurality of different position information items;
arithmetic operation means for obtaining a local time at a current position on the basis of the time difference information corresponding to the current position information, which is stored in the storage means, and the time information acquired by the information acquisition means; and
indicator means for indicating the local time obtained by the arithmetic operation means.

8. A communication terminal device according to claim 7, wherein said information acquisition means acquires date information via said network,
said storage means stores summer time information indicating time periods in which summer time is practiced, in association with the different position information items, and
the arithmetic operation means determines whether the date information acquired by the information acquisition means falls within the time period in which the summer time is practiced, on the basis of the summer time information associated with the current position information, which is stored in the storage means, and if the date information falls within the time period in which the summer time is practiced, the arithmetic operation means adjusts the local time in accordance with the summer time.

9. A local time calculation method comprising:
a first acquisition step of acquiring a current position and a present mean time;
a second acquisition step of acquiring time difference information associated with the current position acquired in the first acquisition step;
arithmetic operation step of obtaining a local time at the current position on the basis of the present mean time acquired in the first acquisition step and the time difference information acquired in the second acquisition step; and
indicating step of indicating the local time obtained in the arithmetic operation step.

10. A local time calculation method according to claim 9, further comprising:
a third acquisition step of acquiring present date information;
a fourth acquisition step of acquiring summer time information indicating a time period in which summer time is practiced at the current position acquired in the first acquisition step;
a determination step of determining whether the present date information acquired in the third step falls within the time period in which the summer time is practiced, on the basis of the summer time information acquired in the fourth acquisition step; and
an adjusting step of adjusting the local time obtained in the arithmetic operation step in accordance with the summer time, when it has been determined in the determination step that the date information falls within the time period in which the summer time is practiced.
